(19) United States
(12) Patent Application Publication
(10) Pub. No.: US 2014/0265356 A1
(43) Pub. Date: Sep. 18, 2014

(54) Fastener

(71) Applicant: GREAT COMPUTER CORPORATION, New Taipei City (TW)

(72) Inventors: Chen-Chien TSAI, New Taipei City (TW); Chia-Liang LU, New Taipei City (TW); Hui-Te YU, New Taipei City (TW)

(73) Assignee: GREAT COMPUTER CORPORATION, New Taipei City (TW)

(21) Appl. No.: 13/846,423

(22) Filed: Mar. 18, 2013

(51) Int. Cl. G11B 33/00

(52) U.S. Cl. CPC G11B 33/005
USPC 292/99

(57) ABSTRACT

A fastener comprises a fixing frame, a sliding base as well as a sliding frame and a swinging arm disposed inside the sliding base. A beveled guide surface of a fastening hook of a fastening rod of the fixing frame is pressed against a front side wall of the sliding base for inserting the fastening hook into a fastening groove in order that the sliding frame is fixed by the fastening rod at a fastening position. When the sliding base moves along a detaching direction from the fastening position, a turning portion of the swinging arm can be turned by pressing against an actuating rod, and a pressing portion of the swinging arm is driven by the turning portion to push the fastening rod upward for unfastening the sliding frame.

### BACKGROUND OF THE INVENTION

1. Field of Invention

The present invention relates to a fastener and more particularly to a fastener with which unfastening can be achieved by turning a swinging arm when a sliding base moves toward a detaching direction.

2. Related Art

Fastener is widely used in common home appliances and industrial products such as for fastening and unfastening external cover of CD player. A fastener can be fastened or locked by pressing an external cover in a force exerting direction by a user, and the fastener can be unfastened or unlocked by pressing the external cover in the same force exerting direction again.

The above fastener mostly uses plastic leaf spring or spring and specific shaped sliding groove is disposed for achieving fastening and unfastening. However, plastic leaf spring or spring has certain life expectancy, elastic fatigue will occur after many times of frequent fastening and unfastening which will result in poor resilience and unable to unfasten speedily and promptly. Furthermore, conventional fastener has weak fastening strength and damages can occur due to exceeding exerting force or impact.

### SUMMARY OF THE INVENTION

In view of the above problems and in order to allow fastener to take large load and impact, the present invention of a fastener employs elements which do not have the problem of elastic fatigue for enhancing stability and life expectancy.

A primary objective of the present invention is to provide a fastener with a swinging arm pivotally disposed on a side of a sliding frame in order that when the sliding frame is fixed at a fastening position by a fastening rod and the sliding frame is moved along a detaching direction, a turning portion of the swinging arm can be turned by pressing against an actuating rod for driving a pressing portion of the swinging arm to push a fastening hook of the fastening rod upward and for unfastening the sliding frame.

In order to achieve the above-mentioned objectives, a fastener provided by the present invention comprises a fixing frame, a sliding base and a swinging arm disposed inside the sliding base. The fixing frame comprises a fastening rod pivotally disposed on the fixing frame. A fastening hook is disposed at an end of the fastening rod and a beveled guide surface is disposed along a side of the fastening hook. A sliding frame is disposed inside the sliding base. A fastening groove is disposed on a front side of the sliding frame so that the beveled guide surface of the fastening rod can be pressed against a front side wall of the sliding frame for inserting the fastening hook into the fastening groove and fixing the sliding frame at a fastening position by the fastening rod. The swinging arm is pivotally disposed on the sliding frame inside the sliding base. A pressing portion and a turning portion are disposed on the swinging arm, and the pressing portion can be actuated by the turning portion to turn. Thereby, when the sliding frame moves along a detaching direction from the fastening position, the turning portion of the swinging arm can be turned by pressing against an actuating rod, and the pressing portion is driven by the turning portion to push the fastening rod upward for unfastening the sliding frame.

The fixing frame and the sliding base of the fastener of the present invention can be disposed on devices with a heavy weight respectively so that they can be coupled together stably. The device disposed with the sliding base can be pushed against for achieving speedy unfastening.

The present invention will become more fully understood by reference to the following detailed description thereof when read in conjunction with the attached drawings.

### BRIEF DESCRIPTION OF THE DRAWINGS

FIG. 1 is an exploded view of a fastener according to an embodiment of the disclosure;

FIG. 2 is a perspective view of the fastener being fastened according to the embodiment in FIG. 1;

FIG. 3 is a perspective view of the fastener being fastened and with a sliding base dismounted according to the embodiment in FIG. 1;

FIG. 4A is a side view of the fastener with the unfastened sliding base according to the embodiment in FIG. 1;

FIGS. 4B to 4D are side views of the fastener with the sliding base being moved towards a fixing frame according to the embodiment in FIG. 1; and

FIGS. 5A to 5E are side views of the fastener with the sliding base being unfastened according to the embodiment in FIG. 1.

### DETAILED DESCRIPTION OF THE INVENTION

Please refer to FIGS. 1 to 3, which show a fastener according to an embodiment of the disclosure. The fastener comprises a fixing frame 1, a sliding base 20 as well as a sliding frame 2 and a swinging arm 21 disposed inside the sliding base 20.

The fixing frame 1 comprises a connecting frame 10. An L-shaped fastening rod 11 is pivotally disposed on an upper part of the fixing frame 1, and an actuating rod 12 is disposed on a lower part of the fixing frame 1. The fastening rod 11 is pivotally disposed on the fixing frame 1 by using a shaft 110 so that an end of the fastening rod 11 is pressed against on the connecting frame 10 for limiting a turning position of the fastening rod 11. The end of the fastening rod 11 pressing against the connecting frame 10 has a stopping surface 114. A fastening hook 111 is disposed at another end of the fastening rod 11. An outer side of the fastening hook 111 facing toward the sliding frame 2 has a beveled guide surface 112, and an inner side of the fastening hook 111 has a fastening surface 113. A front end 121 of the actuating rod 12 is extended passing an outer side of the fastening hook 111 of the fastening rod 11 and is extended protrudingly and upwardly.

A side wall 201 is disposed on a front side of the sliding base 20 and a guiding edge 202 is disposed on a top edge of the side wall 201. The sliding frame 2 is fixed inside the sliding base 20. A fastening groove 22 is disposed on a front side of the sliding frame 2 facing the sliding base 20. A fastening side 221 is disposed on a front side of the fastening groove 22 for fastening with the fastening surface 113.

The swinging arm 21 is a structure in a rough L shape and is pivotally disposed on the sliding frame 2 at a back side of the fastening groove 22 by using a shaft 220. A pressing portion 211 and a turning portion 212 are disposed at two ends of the swinging arm 21 respectively. The pressing portion 211 can be actuated by the turning portion 212 to turn relative to the shaft 220. The pressing portion 211 has a length extending to reach a side wall 223 of the fastening groove 22. Furthermore, an arc-shaped guiding surface is disposed on an outer surface of the turning portion 212, and a wave shaped guiding surface is disposed on an outer surface of the pressing portion 211.

As shown in FIG. 4A, when the fastener is embodied and the sliding base 20 is at an unfastening position, the fastening rod 11 is located at a position outside the sliding base 20 and the sliding frame 2. A lower end of the fastening rod 11 is pressed against the connecting frame 10. The pressing portion 211 and the turning portion 212 of the swinging arm 21 can be turned freely and are suspending by left and right sides of the shaft 220. When the sliding base 20 is moved along a coupling direction toward the fixing frame 1, the beveled, guide surface 112 of the fastening rod 11 is pressed against the guiding edge 202 of the sliding base 20 first. At the same time, the pressing portion 211 of the swinging arm 21 is moved to locate between the fastening rod 11 and the actuating rod 12 as shown in FIG. 4B. When the sliding base 20 is displaced continuously, the fastening hook 111 of the fastening rod 11 is moved along the side wall 223 of the fastening groove 22 toward the fastening groove 22 gradually. At the same time, the fastening hook 111 of the fastening rod 11 is turned upward as shown in FIG. 4C until the fastening hook 111 of the fastening rod 11 is inserted inside the fastening groove 22 as shown in FIG. 4D. The fastening side 221 of the fastening groove 22 is fastened and hooked with the fastening surface 113 of the fastening hook 111 in order that the sliding frame 2 and the sliding base 20 are fixed at a fastening position by the fastening rod 11. At this point, the lower end of the fastening rod 11 is restored to be pressing against the connecting frame 10.

As shown in the fastening status in FIG. 4D, a right side of the turning portion 212 of the swinging arm 21 is pressed against the front end 121 of the actuating rod 12. When the sliding base 20 is required to be unfastened, a force can be exerted along the coupling direction again to cause the sliding base 20 to move toward the fixing frame 1. At the same time, the turning portion 212 of the swinging arm 21 is moved to the right side of the front end 121 of the actuating rod 12 until the side wall 201 of the sliding base 20 is pressed against the stopping surface 114 of the fastening rod 11 as shown in FIG. 5A. Then, the sliding base 20 in the fastening status can be moved along a detaching direction opposite to the coupling direction as shown in FIG. 5B to cause the arc-shaped guiding surface of the turning portion 212 of the swinging arm 21 to turn by pressing against the front end 121 of the actuating rod 12. And, the pressing portion 211 is driven by the turning portion 212 to turn upward and to push the fastening hook 111 of the fastening rod 11 as shown in FIG. 5C. At this point, the fastening hook 111 is moved upward along the wave shaped guiding surface of the pressing portion 211 and detached from the fastening groove 22 until the lower end of the fastening hook 111 is moved away from the front side wail 223 of the fastening groove 22 as shown in FIG. 5D. The unfastening of the sliding base 20 and the sliding frame 2 is achieved when the turning portion 212 of the swinging arm 21 is moved to the left of the front end 121 of the actuating rod 12 as shown in FIG. 5E.

Thereby, the elements of the fixing frame 1, the fastening rod 11 and the actuating rod 12 can be disposed on a A device (not shown in the drawings) through the connecting frame 10; and the elements of the sliding frame 2 and the swinging arm 21 can be disposed on a B device (not shown in the drawings) through the sliding base 20 in order to fasten the devices A and B together.

Therefore, the structures of the fastener of the present invention can sustain large load and impact. The fixing frame and the sliding base can be disposed on devices with a heavy weight respectively, especially on devices with sliding rail which can be moved easily by pushing. Thus, the devices can be coupled stably and unfastened speedily. The elements of the fastener of the present invention do not have the problem of elastic fatigue and the life expectancy of the fastener can be extended.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A fastener, comprising:
a fixing frame comprising a fastening rod pivotally disposed on the fixing frame, a fastening hook being disposed at an end of the fastening rod and a beveled vide surface being disposed along a side of the fastening hook;
a sliding base, a sliding frame being disposed inside the sliding base, a fastening groove being disposed on a front side of the sliding frame for the beveled guide surface of the fastening rod to press against a front side wall of the sliding frame for inserting the fastening hook into the fastening groove and fixing the sliding frame at a fastening position by the fastening rod; and
a swinging arm pivotally disposed on the sliding frame inside the sliding base, a pressing portion and a turning portion being disposed on the swinging arm, the pressing portion being actuated by the turning portion to turn, thereby, when the sliding frame moving along a detaching direction from the fastening position, the turning portion of the swinging arm being turned by pressing against an actuating rod, and the pressing portion being driven by the turning portion to push the fastening rod upward for unfastening the sliding frame.

2. The fastener as claimed in claim 1, wherein the fastening hook has a fastening surface, and a fastening side is disposed inside the fastening groove for fastening with the fastening surface.

3. The fastener as claimed in claim 1, wherein the actuating rod is disposed on the fixing frame and is extended passing an outer side of the fastening hook of the fastening rod.

4. The fastener as claimed in claim 1, wherein the swinging arm is an L-shaped structure, and the pressing portion and the turning portion are disposed at two ends of the L-shaped structure respectively.

5. The fastener as claimed in claim 1, wherein the swinging arm has a shaft for pivotally connecting the sliding frame, and the shaft is disposed at a position behind a back side of the fastening groove.

6. The fastener as claimed in claim 1, wherein the fixing frame is disposed on a connecting frame in order that another end of the fastening rod is pressed against on the connecting frame.
